(19) United States
(12) Patent Application Publication
(10) Pub. No.: US 2019/0099327 A1
(43) Pub. Date: Apr. 4, 2019

(54) PRESSURE APPLICATION DEVICE AND METHOD

(71) Applicants: Melody Cooper, West Vancouver (CA); Paul Rivas, West Vancouver (CA)

(72) Inventors: Melody Cooper, West Vancouver (CA); Paul Rivas, West Vancouver (CA)

(21) Appl. No.: 15/721,399

(22) Filed: Sep. 29, 2017

(51) Int. Cl. A61H 39/04

(52) U.S. Cl. CPC A61H 39/04; A61H 2205/12; A61H 2205/081

(57) ABSTRACT

A pressure application device includes a polyhedron shaped body having a base, at least one side surface, and a contact point opposite of the base. The pressure application device is configured for applying targeted pressure to a body part during a restorative exercise or other activity.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pain relieving devices of existing art and more specifically relates to a pressure application device.

### RELATED ART

Many people suffer from muscle soreness, stiffness and tension. Often, this is caused by a variety of factors such as a direct injury or trauma, overuse, poor posture, and even stress. These factors cause restriction in the fascia, a fibrous connective tissue that surrounds muscles and provides support and structure to the body. The fascia and muscles form an interconnected network, and restriction or tightness to fascia can lead to overcompensation and pain other places in the body.

One recognized method for treating these types of injuries and managing pain is massage therapy. Deep tissue techniques have been developed to enable more focused massage work, focusing on a specific joint or muscle. Deep tissue massage is typically performed by a trained professional. By performing deep tissue techniques, the professional accesses deeper layers of the soft tissue than basic massage techniques. These therapy techniques have been refined into a technique known as myofascial release or myofascial therapy. Myofascial therapy targets the massage on the fascia by applying initial pressure at a particular location and then gently stretching the fascia.

Trigger point therapy focuses and applies the pressure at a particular trigger point on the body. Trigger points are areas in the human body that have been observed to be primary sources of myofascial pain and restriction. Trigger points cause pain locally or in other locations in the body along associated nerve pathways. Treatment of the affected trigger point can relieve pain at the particular area as well as throughout the affected portion of the muscular network. It is not always convenient or cost-effective to seek these types of therapies from a trained professional. A suitable solution is desired.

U.S. Pat. No. 5,788,657 to Donald S. Burns relates to a pain relieving pressure device. The described pain relieving pressure device includes a small hand-held device having a body of electrically insulating material, and a central rod of electrically conductive material provides for the rod extending beyond a proximal and a distal ends of the body to form electrical contacts. Therefore an electrical conduction path is set-up between the contacts. This path is advantageously used to establish a charge state on the skin surface so as to help in relieving localized pain. A pointed proximal end of the device enables an effective massaging action when the device is brought into contact with the skin and pressed into it.

### SUMMARY OF THE INVENTION

In view of the foregoing disadvantages inherent in the known pain relieving devices art, the present disclosure provides a novel pressure application device. The general purpose of the present disclosure, which will be described subsequently in greater detail, is to provide a device that may be used unassisted, in combination with restorative exercises, to relieve pain at targeted locations on a human body.

A pressure application device is disclosed herein. The pressure application device may include a polyhedron shaped body having a base, at least one side surface, and a contact point opposite of the base. The pressure application device may further comprise foam and be configured for applying targeted pressure to a body part during a restorative exercise.

According to another embodiment, a method for using a pressure application device is also disclosed herein. The method for using a pressure application device may include providing a pressure application device, selecting a location on a human body for applying targeted pressure, placing the pressure application device on a surface, and positioning the location on the human body against the contact point of the pressure application device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pressure application device, constructed and operative according to the teachings of the present disclosure.

FIG. 1 is a perspective view of the pressure application device during an ‘in-use’ condition, according to an embodiment of the disclosure.

FIG. 2 is a top perspective view of the pressure application device of FIG. 1, made structured and arranged in assorted sizes, according to an embodiment of the present disclosure.

FIG. 3 is a perspective view of the pressure application device of FIG. 1, according to an embodiment of the present disclosure.

FIG. 4 is a bottom perspective view of the pressure application device of FIG. 1, according to an embodiment of the present disclosure.

FIG. 5 is a flow diagram illustrating a method for using a pressure application device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pain relieving devices and more particularly to a pressure application device as used to provide a device that may be used unassisted, in combination with restorative exercises, to relieve pain at targeted locations on a human body.

Generally speaking, the pressure application device may be a pyramid-shaped object that may come in a variety of sizes. The sizes included may be classified in 3 separate categories generally referred to as small, medium, and large. The device may be used to apply pressure to sore areas of the back or other body parts. The device may further be configured for particular use in both Yin and Restorative yoga.

A user may lay the device on the floor towards a desired point on their back, foot, or other body part and then drape their body over it. By doing this, the device may provide a relaxing experience as pressure points in the body may be targeted without having to use other muscles in order to facilitate relief. The device may be used without the assistance of a spotter, guide, or professional therapist.

The device may be configured from foam, cork, bamboo, and many other materials that may be suitable for delivering targeted resistance against a body part. The device may further be configured in a variety of densities, depending on the firmness of the pressure desired. Again, the device may be configured in a variety of sizes. Those sizes may be range from a micro size measuring approximately 2.5 inches high, to a large size measuring approximately 5 or more inches high. The top of the device may be rounded in shape similar to a knuckle for applying concentrated pressure to a specific body part or region.

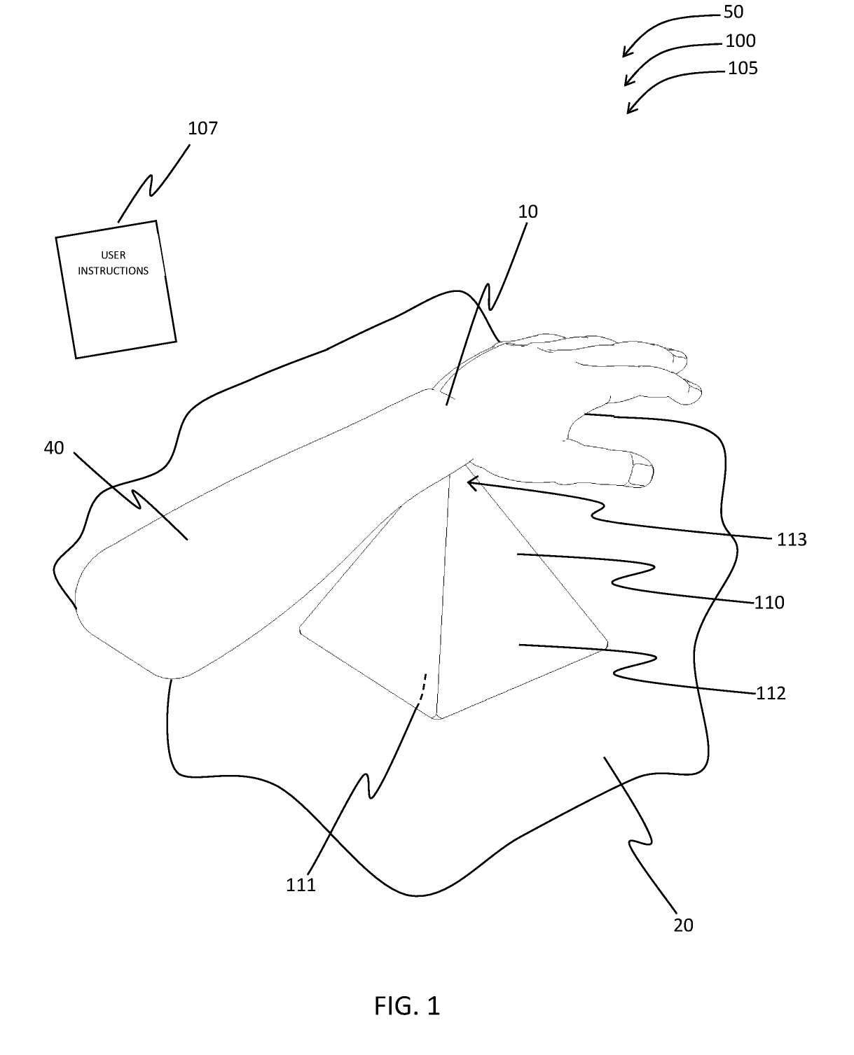

Referring now more specifically to the drawings by numerals of reference, there is shown in FIGS. 1-4, various views of a pressure application device 100.

FIG. 1 shows a pressure application device 100 during an ‘in-use’ condition 50, according to an embodiment of the present disclosure. Here, the pressure application device 100 may be beneficial for use by a user 40 to relieve pain at targeted locations on a human body. As illustrated, the pressure application device 100 may include a polyhedron shaped body 110 having a base 111 configured for use on a floor surface 20, at least one side surface 112, and a contact point 113 opposite of said base 111. The contact point 113 of said device may be configured to apply targeted pressure to a body part 10 during a restorative exercise.

According to one embodiment, the pressure application device 100 may be arranged as a kit 105. In particular, the pressure application device 100 may further include a set of instructions 107. The instructions 107 may detail functional relationships in relation to the structure of the pressure application device 100 such that the pressure application device 100 can be used, maintained, or the like, in a preferred manner.

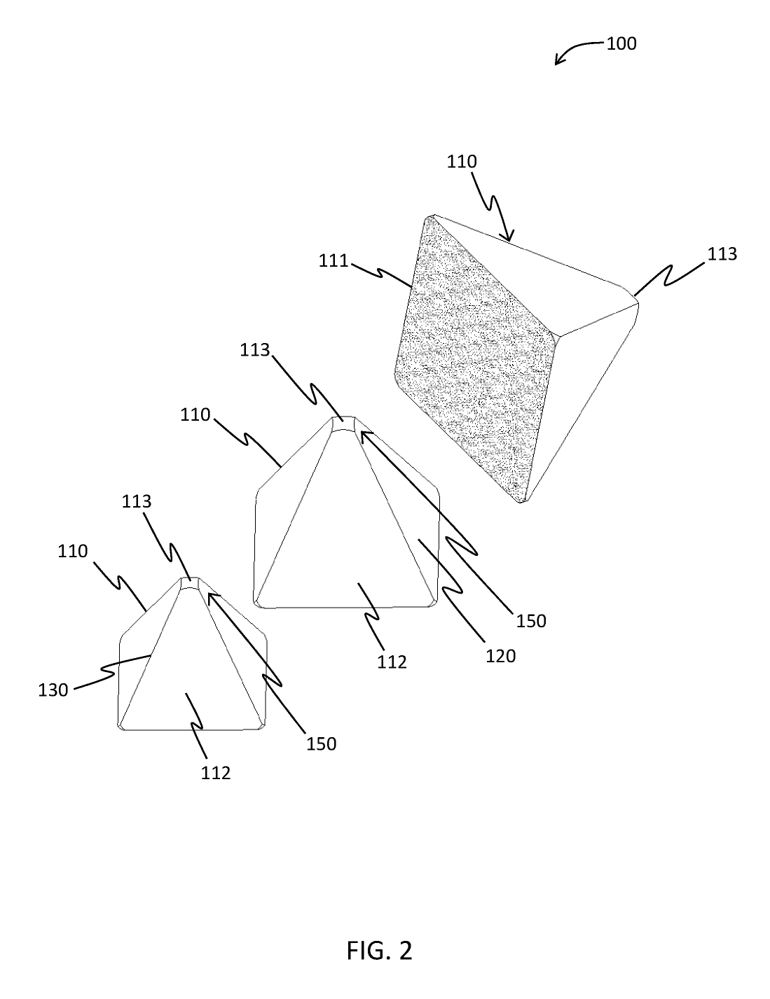

FIG. 2 shows the pressure application device 100 of FIG. 1, according to an embodiment of the present disclosure. As above, the pressure application device 100 may include a polyhedron shaped body 110 having a base 111, at least one side surface 112, and a contact point 113 opposite of said base 111. In this embodiment, the polyhedron shaped body 110 may be configured as a pyramid 130 comprising foam 120. The contact point 113 may be rounded 150 for applying targeted pressure in a more comfortable manner.

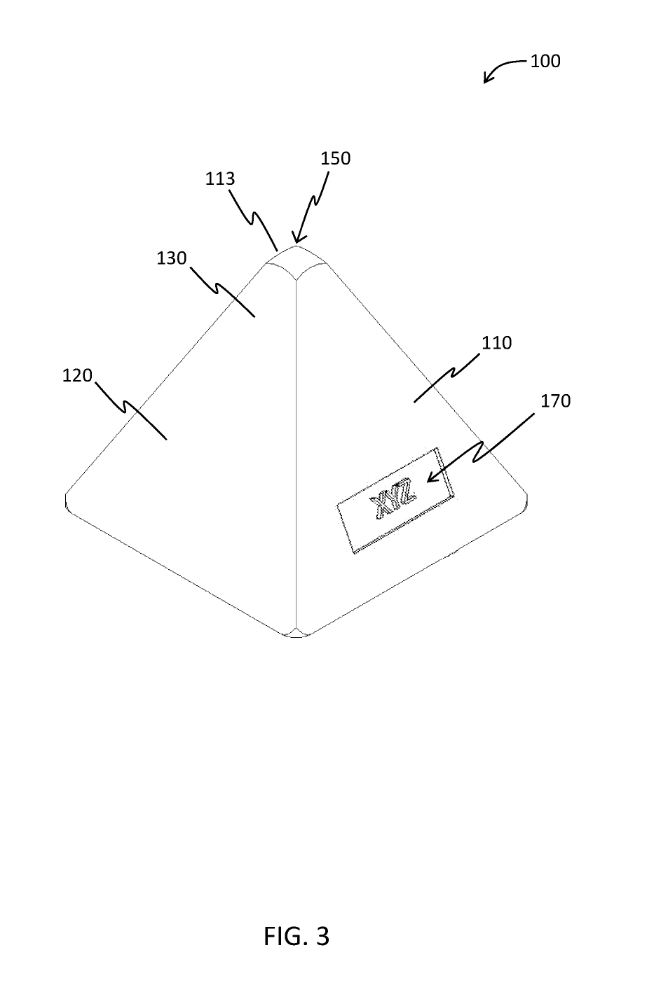

FIG. 3 is a perspective view of the pressure application device 100 of FIG. 1, according to an embodiment of the present disclosure. In this illustration, the pressure application device 100 may include a polyhedron shaped body 110 comprising foam 120 and further configured as a pyramid 130. The polyhedron shaped body 110 may include a contact point 113 that is rounded 150. The pressure application device 100 may also feature decorative indicia 170 configured to represent a brand, logo, design, or personal effect.

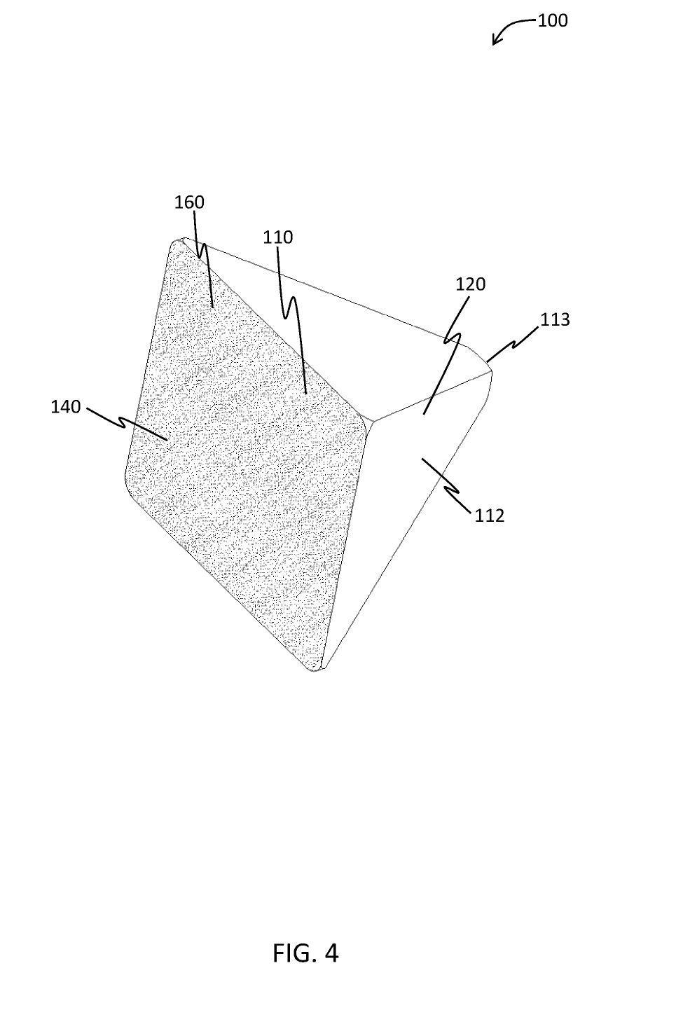

FIG. 4 is a bottom perspective view of the pressure application device 100 of FIG. 1, according to an embodiment of the present disclosure. In this illustration, the pressure application device 100 may include a polyhedron shaped body 110 comprising foam 120. The polyhedron shaped body 110 may also include at least one side surface 112 and a contact point 113. The bottom of the pressure application device 100 may be planar 140 and further include a non-skid texture 160 configured to remain in position during a restorative exercise routine.

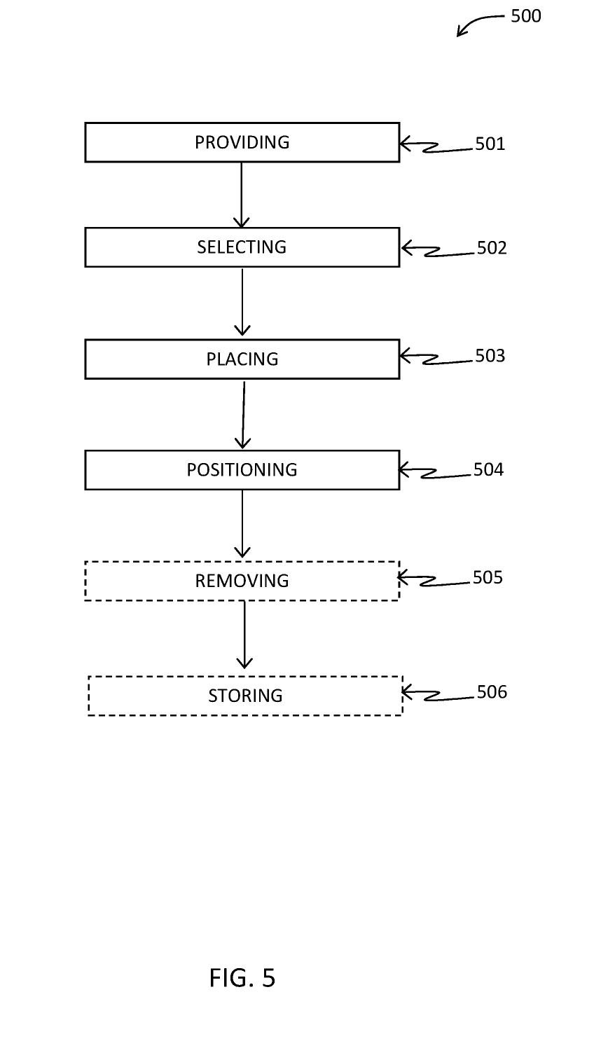

FIG. 5 is a flow diagram illustrating a method for using 500 a pressure application device 100, according to an embodiment of the present disclosure. In particular, the method for using 500 a pressure application device 100 may include one or more components or features of the pressure application device 100 as described above. As illustrated, the method for using 500 a pressure application device 100 may include the steps of: step one 501, providing a pressure application device 100 including a polyhedron shaped body 110 having a base 111, at least one side surface 112, and a contact point 113 opposite of said base 111; step two 502, selecting a location on a human body for applying targeted pressure; step three 503, placing said pressure application device 100 on a surface; and step four 504, positioning said location on said human body against said contact point 113 of said pressure application device 100.

It should be noted that step five 505, removing said pressure application device 100 from said surface, and step six 506, storing said pressure application device 100, are optional steps and may not be implemented in all cases. Optional steps of a method for using 500 a pressure application device 100 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for pressure application device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pressure application device, the pressure application device comprising:
a polyhedron shaped body having a base, at least one side surface, and a contact point opposite of said base;
wherein said pressure application device comprises foam; and
wherein the contact point of said device is configured to apply targeted pressure to a body part during a restorative exercise.

2. The pressure application device of claim 1, wherein said polyhedron shaped body is a pyramid.

3. The pressure application device of claim 1, wherein said base is planar in configuration.

4. The pressure application device of claim 1, wherein each of said at least one side surfaces is symmetrical.

5. The pressure application device of claim 1, wherein said contact point is rounded.

6. The pressure application device of claim 1, wherein said polyhedron shaped body is also formed of material selected from the group consisting of plastic, cork, and bamboo.

7. The pressure application device of claim 6, wherein said material is configured to be non-rigid.

8. The pressure application device of claim 6, wherein said material permits longitudinal and lateral bending of said device during said restorative exercise.

9. The pressure application device of claim 1, wherein said device is less than 7 inches in height from said base to said contact point.

10. The pressure application device of claim 1, wherein said device features decorative indicia.

11. The pressure application device of claim 1, wherein said device weighs less than 10 lbs.

12. The pressure application device of claim 1, wherein said base includes a non-skid texture configured to remain in position during said restorative exercise.

13. The pressure application device of claim 1, wherein said body part is a back of a user.

14. The pressure application device of claim 1, wherein said body part is a foot of a user.

15. The pressure application device of claim 1, wherein said device is configured for use on a floor surface.

16. The pressure application device of claim 1, wherein said device is portable.

17. A pressure application device, the pressure application device comprising:
a polyhedron shaped body having a base, at least one side surface, and a contact point opposite of said base;
wherein said pressure application device comprises foam;
wherein the contact point of said device is configured to apply targeted pressure to a body part during a restorative exercise;
wherein said polyhedron shaped body is a pyramid;
wherein said base is planar in configuration;
wherein each of said at least one side surfaces is symmetrical;
wherein said contact point is rounded;
wherein said polyhedron shaped body is also formed of material selected from the group consisting of plastic, cork, and bamboo;
wherein said material is configured to be non-rigid;
wherein said material permits longitudinal and lateral bending of said device during said restorative exercise;
wherein said device is less than 7 inches in height from said base to said contact point;
wherein said device features decorative indicia;
wherein said device weighs less than 10 lbs;
wherein said base includes a non-skid texture configured to remain in position during said restorative exercise;
wherein said body part is a back of a user;
wherein said body part is a foot of a user;
wherein said device is configured for use on a floor surface; and
wherein said device is portable.

18. The pressure application device of claim 17, further comprising set of instructions; and
wherein the device is arranged as a kit.

19. A method for using a pressure application device, the method comprising the steps of:
providing a pressure application device including a polyhedron shaped body having a base, at least one side surface, and a contact point opposite of said base;
selecting a location on a human body for applying targeted pressure;
placing said pressure application device on a surface;
positioning said location on said human body against said contact point of said pressure application device.

20. The method of claim 19, further comprising the steps of:
removing said pressure application device from said surface;
storing said pressure application device.
